(19) United States
(12) Patent Application Publication
(10) Pub. No.: US 2013/0278496 A1
(43) Pub. Date: Oct. 24, 2013

(54) ELECTRONIC DISPLAY DEVICE AND METHOD FOR ADJUSTING USER INTERFACE

(71) Applicant: HON HAI PRECISION INDUSTRY CO., LTD., New Taipei (TW)

(72) Inventor: HSIEH-FU TSAI, New Taipei (TW)

(73) Assignee: HON HAI PRECISION INDUSTRY CO., LTD., New Taipei (TW)

(21) Appl. No.: 13/775,106

(22) Filed: Feb. 22, 2013

(30) Foreign Application Priority Data
Apr. 18, 2012 (TW) 101113864

(51) Int. Cl. G06F 3/00

(52) U.S. Cl. CPC G06F 3/005
USPC 345/156

(57) ABSTRACT

An electronic display device acquires an image of a user in front of a screen of the device. The electronic display device calculates an area of the user in the image of the user and calculates an area ratio of the area of the user in the image of the user to a predefined value. The electronic display device provides a plurality of user interfaces and a plurality of ratio scopes corresponding to the plurality of user interfaces, and selects one of the plurality of user interfaces corresponding to one of the plurality of ratio scopes according to the area ratio located to display the one of the plurality of user interfaces on the screen.

### BACKGROUND

1. Technical Field

Embodiments of the present disclosure generally relate to electronic display devices, and more particularly to a method for adjusting a user interface of an electronic display device.

2. Description of Related Art

An electronic display device, such as a smart TV, can present different user interfaces to satisfy different user favorites. The user interfaces vary in color, typeset, or content. However, if a user in front of the electronic display device changes his/her spot and distance between the user and the electronic display device changes, the electronic display device is not adaptable to the change in spot of the user.

### BRIEF DESCRIPTION OF THE DRAWINGS

FIG. 1 is a schematic diagram of an application environment of one embodiment of an electronic display device in accordance with the present disclosure.

FIG. 2 is a schematic diagram of different user positions and corresponding user interfaces displayed by the electronic display device in FIG. 1.

FIG. 3 is a block diagram of functional modules of the electronic display device in FIG. 1.

FIG. 4 is a schematic diagram of an application environment of another embodiment of the electronic display device in accordance with the present disclosure.

FIG. 5 is a flowchart of one embodiment of a method for adjusting a user interface displayed on a screen of the electronic display device.

FIG. 6 is a flowchart of another embodiment of a method for adjusting a user interface displayed on a screen of the electronic display device.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, JAVA, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

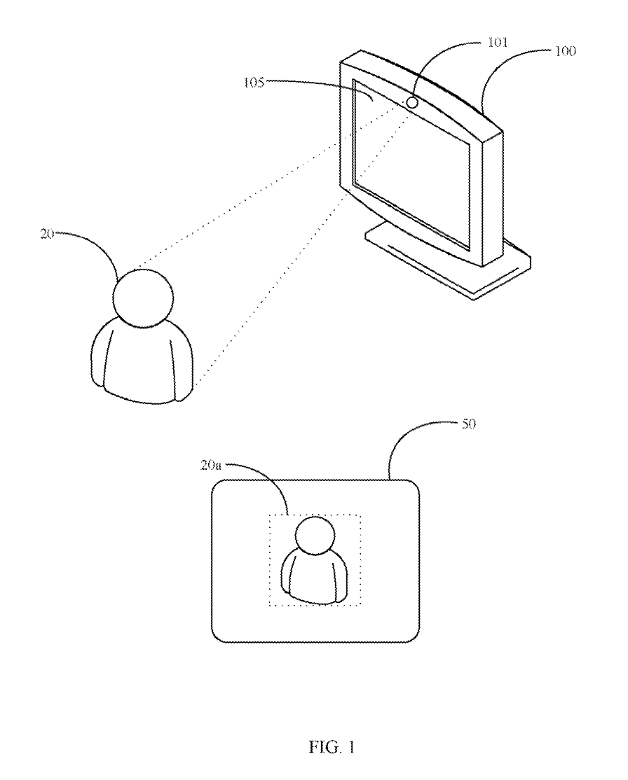

FIG. 1 is a schematic diagram of an application environment of one embodiment of an electronic display device 100 in accordance with the present disclosure. In the present embodiment, a user 20 can be positioned in front of a screen 105 of the electronic display device 100. The screen 105 displays an image 50 having an predefined area which is an area used to display user interfaces. A camera 101 of the electronic display device 100 acquires a user image 20a of the user 20 in front of the screen 105. The electronic display device 100 calculates an area of the user 20 in the user image 20a and calculates an area ratio of the area of the user 20 to the area of the image 50. In one embodiment, the area of the user 20 is an area of the user image 20a, and the area of the user image 20a is equal to an area of a rectangular broken line as shown in the image 50 in FIG. 1.

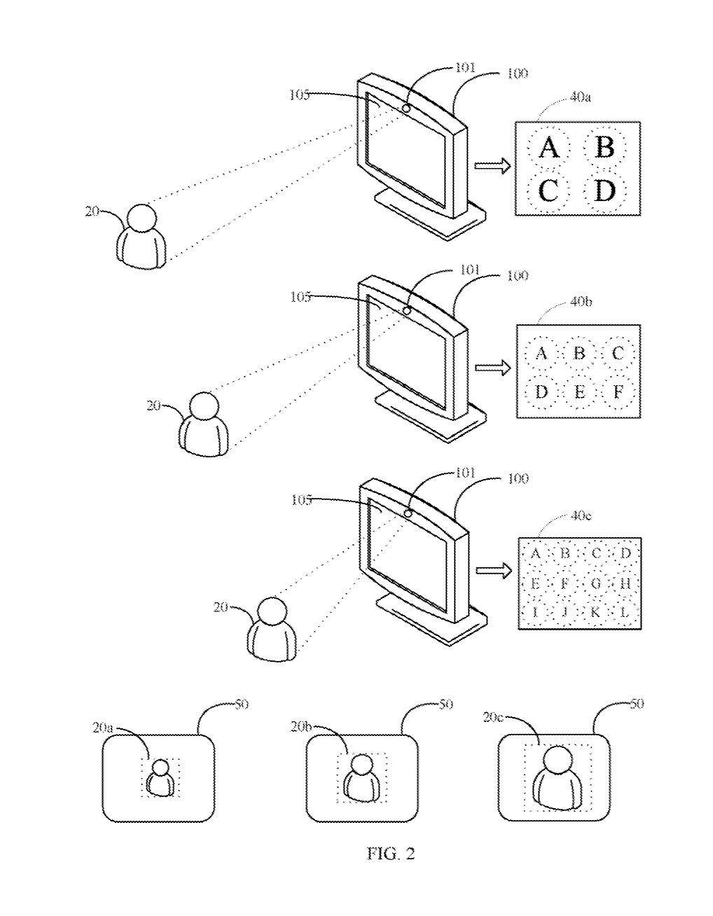

FIG. 2 is a schematic diagram of different user positions and corresponding user interfaces displayed by the electronic display device 100. As shown in FIG. 2, the user 20 may be positioned in three different positions in front of the electronic display device 100, which are a first position, a second position and a third position. The different positions correspond to different distances between the user 20 and the electronic display device 100. In one embodiment, the first position corresponds to the longest distance and the third position corresponds to the shortest distance.

The electronic display device 100 displays different user interfaces according the position of the user 20. For example, as shown in FIG. 2, the electronic display device 100 acquires a user image 20a and displays a brief user interface 40a when the user 20 is in the first position, acquires a user image 20b and displays a normal user interface 40b when the user 20 is in the second position, and acquires a user image 20c and displays a detailed user interface 40c when the user 20 is in the third position. The area of the user 20 is the area of the user image 20a, 20b or 20c. The different positions correspond to different user images. That is, the different positions correspond to different areas of the user 20. In one embodiment, the brief user interface 40a contains less content and uses a larger font size for fonts than the normal user interface 40b and the detailed user interface 40c, and the normal user interface 40b contains moderate amount of content and uses a regular size font (e.g., size 12 or 14 font), and the detailed user interface 40c contains more content and uses a smaller size font than the brief user interface 40a and the normal user interface 40b.

In one embodiment, each user interface mentioned in the preceding paragraph corresponds to a ratio scope which is related to an area ratio of the area of the user 20 to the image 50.

In one embodiment, the brief user interface 40a corresponds to a first ratio scope that is smaller than or equal to a first threshold value. The normal user interface 40b corresponds to a second ratio scope that is between the first threshold and a second threshold. The detailed user interface 40c corresponds to a third ratio scope that is larger than or equal to the second threshold value, and the first threshold is smaller than the second threshold.

In one embodiment, the size of the screen 105 may be about forty-two inches, and the first threshold may be 3% and the second threshold may be 6%.

When the user 20 is in the first position, the area of the user image 20a is smaller than the areas of the user image 20b and 20c. Correspondingly, an area ratio of the area of the user image 20a to the image 50 is 2.5% and is within the first ratio scope, and the electronic display device 100 displays the brief user interface 40a. The brief user interface 40a makes the user 20 easy to distinguish and enjoy the contents displayed on the screen 105 in a long distance.

When the user 20 is in the second position, the area of the user image 20b is smaller than the area of the user image 20c and larger than the area of the user image 20a. Correspondingly, an area ratio of the area of the user image 20b to the image 50 is 5.1% and is within the second ratio scope, and the electronic display device 100 displays the normal user interface 40b. The normal user interface 40b makes the user 20 enjoy appropriate contents and size of font displayed on the screen 105 in a moderate distance.

When the user 20 is in the third position, the area of the user image 20c is larger than the areas of the user image 20b and 20c. Correspondingly, an area ratio of the area of the user image 20c to the image 50 is 7.5% and is within the third ratio scope, and the electronic display device 100 displays the detailed user interface 40c. The detailed user interface 40c makes the user 20 enjoy more contents displayed on the screen 105 in a short distance.

The embodiment presented in FIG. 2 is not to be construed as being limited thereto. Various changes or modifications may be made to the present disclosure according to the size of the screen 105.

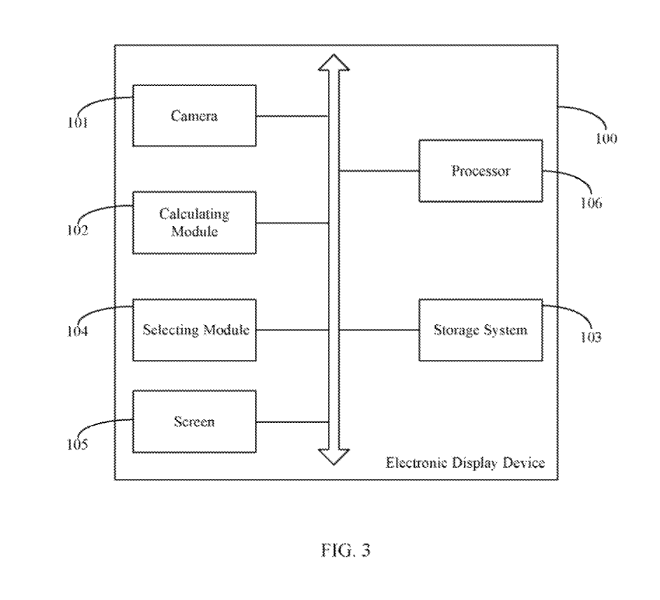

FIG. 3 is a block diagram of functional modules of the electronic display device 100 in FIG. 1. As presented in FIG. 3, the electronic display device 100 includes the camera 101, a calculating module 102, a selecting module 104, the screen 105, a storage system 103 and a processor 106. The modules 102 and 104 may comprise computerized code in the form of one or more programs that are stored in the storage system 103. The computerized code includes instructions that are executed by the processor 106 to provide functions for the modules 102 and 104. In one example, the storage system 103 may include a hard disk drive, a flash memory, a cache or another computerized memory device. The camera 101 acquires an image of a user in front of the screen 105. The calculating module 102 calculates an area of the user in the image of the user and calculating an area ratio of the area of the user in the image of the user to a predefined value. In one embodiment, the area of the user in the image is the area of the user image 20a as presented in FIG. 1. The storage system 103 stores a plurality of user interfaces and a plurality of ratio scopes corresponding to the plurality of user interfaces. In one embodiment, the plurality of user interfaces includes the brief user interface 40a, the normal user interface 40b, and the detailed user interface 40c as presented in FIG. 2, and the plurality of ratio scopes includes a first ratio scope, a second ratio scope and a third ratio scope.

In one embodiment, the brief user interface 40a corresponds to the first ratio scope that is smaller than or equal to a first threshold value, and the normal user interface 40b corresponds the second ratio scope that is between the first threshold and a second threshold, and the detailed user interface 40c corresponds to the third ratio scope that is larger than or equal to the second threshold value. In one embodiment, the first threshold is smaller than the second threshold, and the first threshold and the second threshold could be set by a user. The selecting module 104 selects one of the plurality of user interfaces corresponding to one of the plurality of ratio scopes in which the area ratio located to display the one of the plurality of user interfaces on the screen 105.

In one embodiment, the image of a user acquired by the camera 101 is the image of the face of the user and an area of the user calculated by the calculating module 102 is an area of the face of the user.

In one embodiment, the image of a user acquired by the camera 101 is the image of the eyes of the user and an area of the user calculated by the calculating module 102 is an area of the eyes of the user.

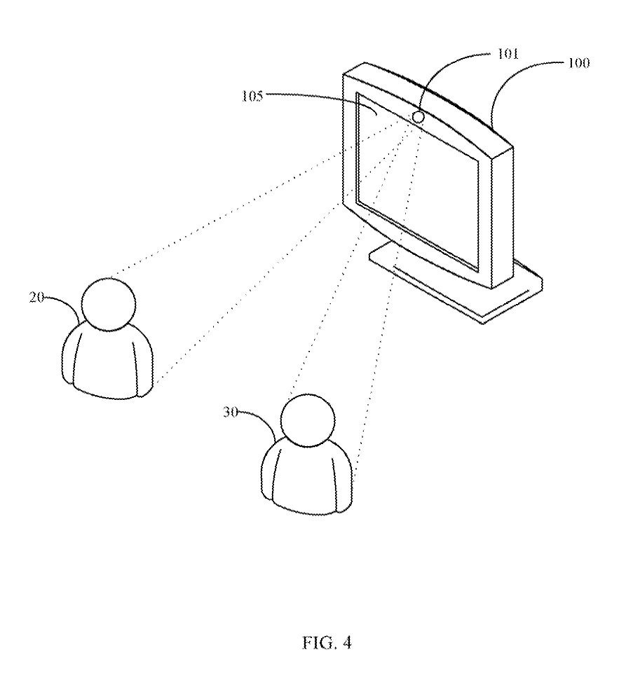

In one embodiment, as presented in FIG. 4, if there are two or more users in front of the screen 105, such as the user 20 and a user 30, the camera 101 acquires images of the user 20 and the user 30, and the calculating module 102 calculates an average value of the areas of the images of the user 20 and the user 30 and calculates an area ratio of the average value to a predefined value, and the selecting module 104 selects a user interface according to the area ratio.

The present disclosure is not limited to acquire the eye, face of a user in front of the screen 105 as mentioned above. Other part of a user body could be acquired by the camera 101 and be taken into account when the electronic display device 100 selects a user interface.

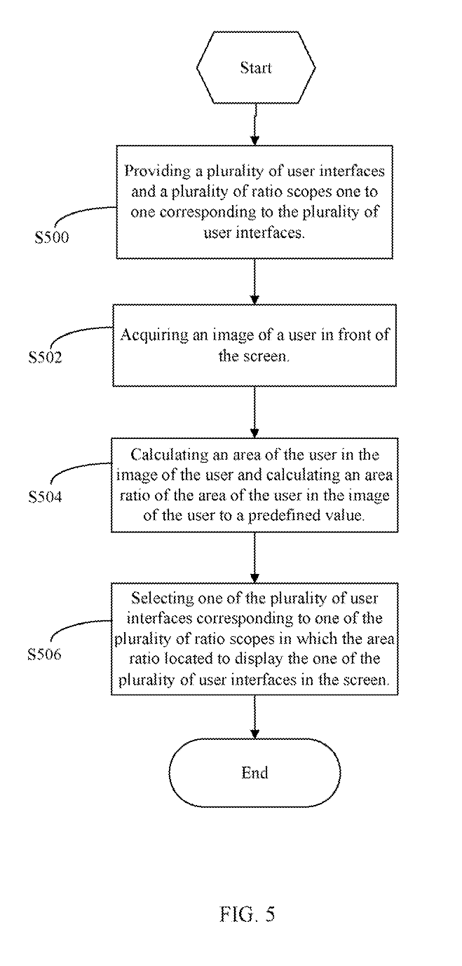

FIG. 5 is a flowchart of one embodiment of a method for adjusting a user interface displayed on the screen 105 of the electronic display device 100. In one embodiment, the method functions by the modules in FIG. 3 in the manner following.

In block S500, the storage system 103 provides a plurality of user interfaces and a plurality of ratio scopes one to one corresponding to the plurality of user interfaces.

In block S502, the camera 101 acquires an image of a user in front of the screen.

In block S504, the calculating module 102 calculates an area of the user in the image of the user and calculates an area ratio of the area of the user in the image of the user to a predefined value.

In block S506, the selecting module 104 selects one of the plurality of user interfaces corresponding to one of the plurality of ratio scopes in which the area ratio located to display the one of the plurality of user interfaces on the screen 105.

In one embodiment, the storage system 103 provides a plurality of user interfaces and a plurality of ratio scopes one to one corresponding to the plurality of user interfaces. The plurality of user interfaces includes the brief user interface 40a, the normal user interface 40b, and the detailed user interface 40c as presented in FIG. 2, and the plurality of ratio scopes includes a first ratio scope, a second ratio scope, and a third ratio scope. The brief user interface 40a corresponds to the first ratio scope that is smaller than or equal to a first threshold value, and the normal user interface 40b corresponds to the second ratio scope that is between the first threshold and a second threshold, and the detailed user interface 40c corresponds to the third ratio scope that is larger than or equal to the second threshold value.

In another embodiment, in block S500, the camera 101 acquires an image of the face of the user, and in block S502, the calculating module 102 calculates an area of the face in the image of the face of the user and calculates an area ratio of the area of the face to a predefined value.

In another embodiment, in block S500, the camera 101 acquires an image of the eye of the user, and in block S502, the calculating module 102 calculates an area of the eye in the image of the eye of the user and calculates an area ratio of the area of the eye to a predefined value.

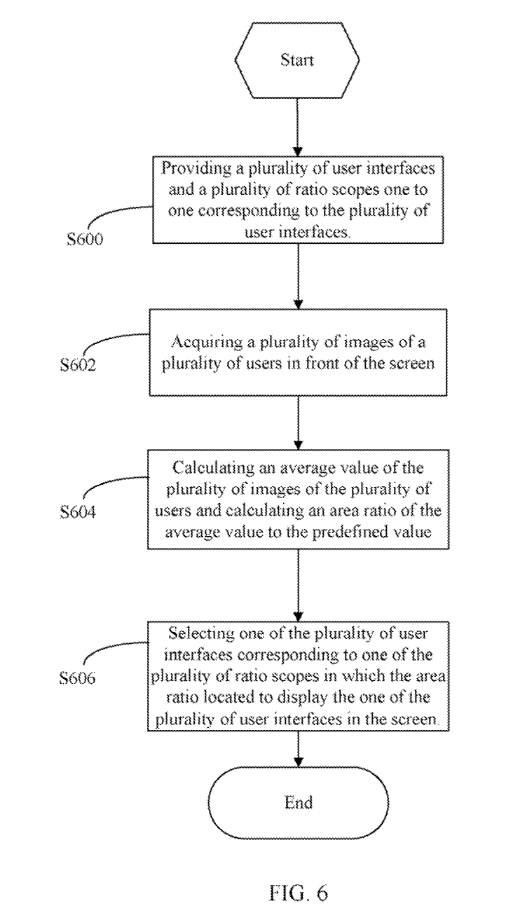

FIG. 6 is a flowchart of another embodiment of a method for adjusting a user interface displayed on the screen 105 of the electronic display device 100. The present embodiment functions in the application environment presented in FIG. 4 and by the modules in FIG. 3 in the manner following.

In block S602, the camera 101 acquires a plurality of images of a plurality of users in front of the screen 105.

In block S604, the calculating module 102 calculates an average value of the plurality of images of the plurality of users and calculates an area ratio of the average value to a predefined value.

In the present embodiment, the block S600-S606 are same as S500-506, and introductions related to the block S600-S606 are omitted.

The method and the electronic display device 100 present different user interfaces to adapt a change of a position of a user in front of the device automatically and greatly improve user experience.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic display device, comprising:
at least one processor;
a screen displaying a user interface;
a camera acquiring an image of a user in front of the screen;
a storage system storing a plurality of user interfaces and a plurality of ratio scopes corresponding to the plurality of user interfaces;
one or more programs that are stored in the storage system and are executed by the at least one processor, the one or more programs comprising:
a calculating module calculating an area of the user in the image of the user and calculating an area ratio of the area of the user in the image of the user to a predefined value;
a selecting module selecting one of the plurality of user interfaces corresponding to one of the plurality of ratio scopes according to the area ratio, to display the one of the plurality of user interfaces on the screen.

2. The electronic display device as claimed in claim 1, wherein the image of the user acquired by the camera is the image of the face of the user and the area of the user calculated by the calculating module is an area of the face of the user.

3. The electronic display device as claimed in claim 1, wherein the image of the user acquired by the camera is the image of the eyes of the user and the area of the user calculated by the calculating module is an area of the eyes of the user.

4. The electronic display device as claimed in claim 1, wherein the camera further acquires a plurality of images of a plurality of users in front of the screen.

5. The electronic display device as claimed in claim 4, wherein the calculating module calculates an average value of the areas of the plurality of images of the plurality of users and calculates an area ratio of the average value to the predefined value.

6. The electronic display device as claimed in claim 1, wherein the plurality of user interfaces comprise a brief user interface, a normal user interface, and an detailed user interface.

7. The electronic display device as claimed in claim 6, wherein a first ratio scope corresponding to the brief user interface is smaller than or equal to a first threshold, a second ratio scope corresponding to the normal user interface is between the first threshold and a second threshold, and a third ratio scope corresponding to the detailed user interface is larger than or equal to the second threshold, wherein the first threshold is smaller than the second threshold.

8. A method for adjusting a user interface displayed on a screen of an electronic display device, comprising:
providing a plurality of user interfaces and a plurality of ratio scopes corresponding to the plurality of user interfaces;
acquiring an image of a user in front of the screen;
calculating an area of the user in the image of the user and calculating an area ratio of the area of the user in the image of the user to a predefined value; and
selecting one of the plurality of user interfaces corresponding to one of the plurality of ratio scopes according to the area ratio to display the one of the plurality of user interfaces on the screen.

9. The method as claimed in claim 8, further comprising:
acquiring an image of the face of the user;
calculating an area of the face in the image of the face of the user and calculating an area ratio of the area of the face to the predefined value.

10. The method as claimed in claim 8, further comprising:
acquiring an image of an eye of the user;
calculating an area of the eye in the image of the eye of the user and calculating an area ratio of the area of the eye to the predefined value.

11. The method as claimed in claim 8, further comprising:
acquiring a plurality of images of a plurality of users in front of the screen;
calculating an average value of the plurality of images of the plurality of users and calculating an area ratio of the average value to the predefined value.

12. The method as claimed in claim 8, further comprising:
providing a brief user interface, a normal user interface and a detailed user interface, and providing a first ratio scope, a second ratio scope, and a third ratio scope, wherein the brief user interface corresponds to the first ratio scope that is smaller than or equal to a first threshold value, and the normal user interface corresponds to the second ratio scope that is between the first threshold and a second threshold, and the detailed user interface corresponds to the third ratio scope that is larger than or equal to the second threshold value, and the first threshold is smaller than the second threshold.
